(19) United States
(12) Patent Application Publication
(10) Pub. No.: US 2026/0080348 A1
(43) Pub. Date: Mar. 19, 2026

(54) SYSTEM AND METHOD FOR CONTENT RETRIEVAL AND EVALUATION

(71) Applicant: Royal Bank of Canada, Toronto (CA)

(72) Inventors: Graham Alexander WATT, Toronto (CA); Muyuan YANG, Toronto (CA); Tristan Meredith James MILNE, Toronto (CA); Tony Ming LEE, Maple (CA); John Andrew BOLTON, Hamilton (CA); Patricia AROCENA, Toronto (CA)

(21) Appl. No.: 18/887,278

(22) Filed: Sep. 17, 2024

(51) Int. Cl. G06Q 10/067; G06F 16/34; G06F 16/383; G06Q 10/0639

(52) U.S. Cl. CPC G06Q 10/067; G06F 16/345; G06F 16/383; G06Q 10/06393

(57) ABSTRACT

There is provided a system for retrieving and analyzing news articles for a company. The news articles may be converted and stored in a vector database. The vector database may be queried based on environmental, social and governance factors and metrics which are the most material to that company. Articles with the highest similarity scores in the vector database may be summarized. Summarized articles may be reranked based on the similarity between a metric and factor. New headlines for highest-ranked articles may be generated together with a rationale on why the article had a high similarity score.

### FIELD

This disclosure relates to the use of generative computing techniques to retrieve and classify content.

### BACKGROUND

Over time, numerous different investment strategies have been considered and implemented by institutions. For example, an emphasis on growth factor-based investing has become more significant among institutions. Consequently, related factors, metrics, and other related considerations have become more financially material to various companies and organizations.

As the volume of news articles and other information becomes increasingly available for a company, it can be challenging to locate, retrieve, and analyze news and other information that is materially relevant to a particular company. This would require significant expenditures of time by subject matter experts, given the volume of information published daily, and a lack of clarity as to how relevant a particular news item is, given that different factors and metrics may be more important for a particular company and less important for a different company.

Accordingly, there is a need for systems and methods which can retrieve and analyze content which is materially relevant to a company. This may enhance the ability to analyze and evaluate companies.

### SUMMARY

According to an aspect, there is provided a method comprising: A method of retrieving content for a company having a company name, the method comprising: receiving a quantitative model for said company, the quantitative model including a plurality of factors, each of said factors having one or more metrics associated therewith, and each of said one or more metrics having a priority weighting indicative of the materiality of the metric; retrieving, by a news retrieval service, a plurality of news articles for said company, said news articles including at least a title and description; converting, by a natural language processing (NLP) embedding model, for each said news articles, said title and said description to a vector comprising a plurality of words; storing each of said vectors in a vector database; generating a query including one of said factors and one of said metrics; converting said generated query to a query vector; determining, based on said vector query, a similarity score for each of said vectors based on said query vector; returning a set of query results, said query results comprising the vectors having the highest similarity scores for said query vector; for each of said set of query results, classifying the vector as one of relevant or not relevant to said one of said factors and said one of said metrics; generating, using said large language model (LLM), a set of summarizations, said set of summarizations including a summarization of each of said set of query results classified as relevant to said one of said factors and said one of said metrics, wherein each of said summarizations is based on a full text content of said corresponding article for said vector determined to be relevant; determining, using a reranker, a similarity score for each of said summarizations in said set of summarizations with said one of said factors and said one of said metrics; selecting a plurality of said summarizations from said set of summarizations, said selected summarizations having the highest similarity scores from said set of summarizations; generating, by an LLM, a headline for each of said articles corresponding to said selected summarizations, and generating a rationale for each of said articles corresponding to said selected summarizations articulating why said article was selected; and displaying, in a user interface, each of said generated headlines and rationales for said articles corresponding to said selected summarizations.

According to another aspect, there is provided a system comprising: A system comprising: a processor; and a computer-readable storage medium having stored thereon computer-executable instructions that, when executed by said processor, cause the processor to perform a method comprising: receiving a quantitative model for said company, the quantitative model including a plurality of factors, each of said factors having one or more metrics associated therewith, and each of said one or more metrics having a priority weighting indicative of the materiality of the metric; retrieving, by a news retrieval service, a plurality of news articles for said company, said news articles including at least a title and description; converting, by a natural language processing (NLP) embedding model, for each said news articles, said title and said description to a vector comprising a plurality of words; storing each of said vectors in a vector database; generating a query including one of said factors and one of said metrics; converting said generated query to a query vector; determining, based on said vector query, a similarity score for each of said vectors based on said query vector; returning a set of query results, said query results comprising the vectors having the highest similarity scores for said query vector; for each of said set of query results, classifying the vector as one of relevant or not relevant to said one of said factors and said one of said metrics; generating, using said large language model (LLM), a set of summarizations, said set of summarizations including a summarization of each of said set of query results classified as relevant to said one of said factors and said one of said metrics, wherein each of said summarizations is based on a full text content of said corresponding article for said vector determined to be relevant; determining, using a reranker, a similarity score for each of said summarizations in said set of summarizations with said one of said factors and said one of said metrics; selecting a plurality of said summarizations from said set of summarizations, said selected summarizations having the highest similarity scores from said set of summarizations; generating, by an LLM, a headline for each of said articles corresponding to said selected summarizations, and generating a rationale for each of said articles corresponding to said selected summarizations articulating why said article was selected; and displaying, in a user interface, each of said generated headlines and rationales for said articles corresponding to said selected summarizations.

According to still another aspect, there is provided a computer-readable storage medium having stored thereon computer-executable instructions that, when executed by said processor, cause the processor to perform a method comprising: A computer-readable storage medium having stored thereon computer-executable instructions that, when executed by said processor, cause the processor to perform a method comprising: receiving a quantitative model for said company, the quantitative model including a plurality of factors, each of said factors having one or more metrics associated therewith, and each of said one or more metrics having a priority weighting indicative of the materiality of the metric; retrieving, by a news retrieval service, a plurality of news articles for said company, said news articles including at least a title and description; converting, by a natural language processing (NLP) embedding model, for each said news articles, said title and said description to a vector comprising a plurality of words; storing each of said vectors in a vector database; generating a query including one of said factors and one of said metrics; converting said generated query to a query vector; determining, based on said vector query, a similarity score for each of said vectors based on said query vector; returning a set of query results, said query results comprising the vectors having the highest similarity scores for said query vector; for each of said set of query results, classifying the vector as one of relevant or not relevant to said one of said factors and said one of said metrics; generating, using said large language model (LLM), a set of summarizations, said set of summarizations including a summarization of each of said set of query results classified as relevant to said one of said factors and said one of said metrics, wherein each of said summarizations is based on a full text content of said corresponding article for said vector determined to be relevant; determining, using a reranker, a similarity score for each of said summarizations in said set of summarizations with said one of said factors and said one of said metrics; selecting a plurality of said summarizations from said set of summarizations, said selected summarizations having the highest similarity scores from said set of summarizations; generating, by an LLM, a headline for each of said articles corresponding to said selected summarizations, and generating a rationale for each of said articles corresponding to said selected summarizations articulating why said article was selected; and displaying, in a user interface, each of said generated headlines and rationales for said articles corresponding to said selected summarizations.

Other features will become apparent from the drawings in conjunction with the following description.

### BRIEF DESCRIPTION OF DRAWINGS

In the figures which illustrate example embodiments,

FIG. 1 is a block diagram depicting components of an example computing system;

FIG. 2 is a block diagram depicting components of an example computing device;

FIG. 3 depicts a simplified arrangement of software at computing device;

FIG. 4 depicts a logical arrangement of components of a content retrieval and analysis system, in accordance with some embodiments;

FIG. 5 depicts an example quantitative model depicting example factors, metrics and associated weights, in accordance with some embodiments; and

FIG. 6 depicts an example user interface which includes headlines and articles relating to factors and metrics, in accordance with some embodiments.

### DETAILED DESCRIPTION

It should be appreciated that although this disclosure contains numerous examples relating to the retrieval and evaluation of text content for companies in the context of investment practices, the systems and methods described herein may have applications in numerous other domains (e.g., use cases in content is required to be evaluated for relevance relative to models and/or model parameters, such as quantitative models). It will be appreciated that the example embodiments described below are merely examples which serve to illuminate aspects of some embodiments of the invention, but these examples are not intended to be limiting.

Some embodiments described herein may relate to the use of factors which have been identified as financially material to a company to identify and retrieve relevant news articles. As used herein, the term “factors” may relate to general topics, whereas “metrics” may be more detailed or granular subtopics of a factor. In some embodiments, a plurality of factors and metrics may be present in a quantitative model.

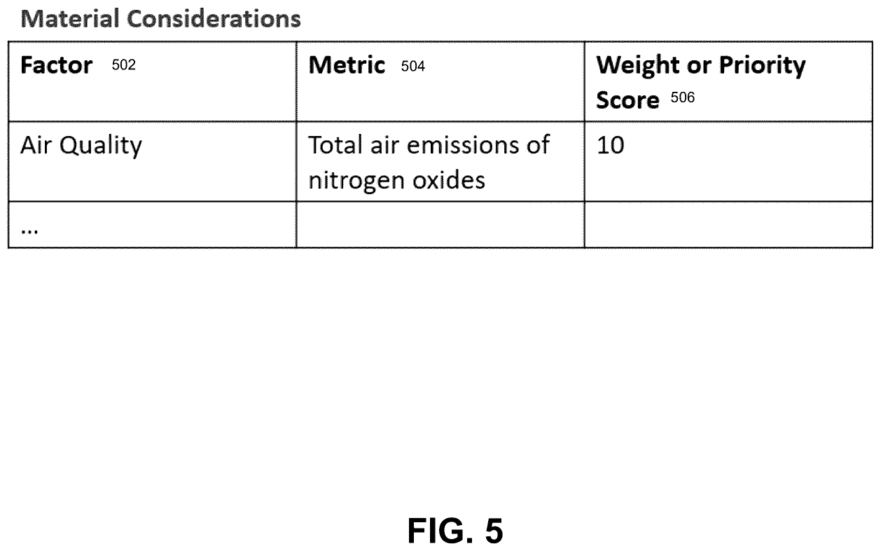

Institutions may use models which evaluate a company based on a combination of financial performance, and other factors and metrics. For example, FIG. 5 depicts an example of a quantitative model feature considered material to a company. In this example case as depicted in FIG. 5, the factor 502 is air quality, and the metric 504 is the total air emissions of nitrogen oxides. In some embodiments, each metric may be given a priority score or weight 506 which corresponds to the degree to which the metric is material to a company. For example, for an automotive company, metrics relating to air pollution may be given a higher weight than metrics relating to employee renumeration and tax compliance. It should be appreciated that air quality is merely an example factor, and that embodiments described herein may be configured to assign a weighting to virtually any factor that can be described with text. In some embodiments, the use of factors which can be described using text may facilitate and enable interaction and/or communication between large language models (LLMs) and quantitative models to improve the overall performance of the system in identifying and retrieving relevant content.

Some embodiments of systems and methods described herein may enable automated information comparisons at scale. In particular, some embodiments may leverage communication between Large Language Models (LLMs) and the various quantitative model architectures which have been developed by institutions to identify and prioritize certain factors and metrics. Systems and methods described herein may be configured to retrieve and identify content relating to factors 502 and metrics 504 in news articles for a company, and/or evaluate how closely the content aligns with the factors and metrics from quantitative models and factor materiality weights 506.

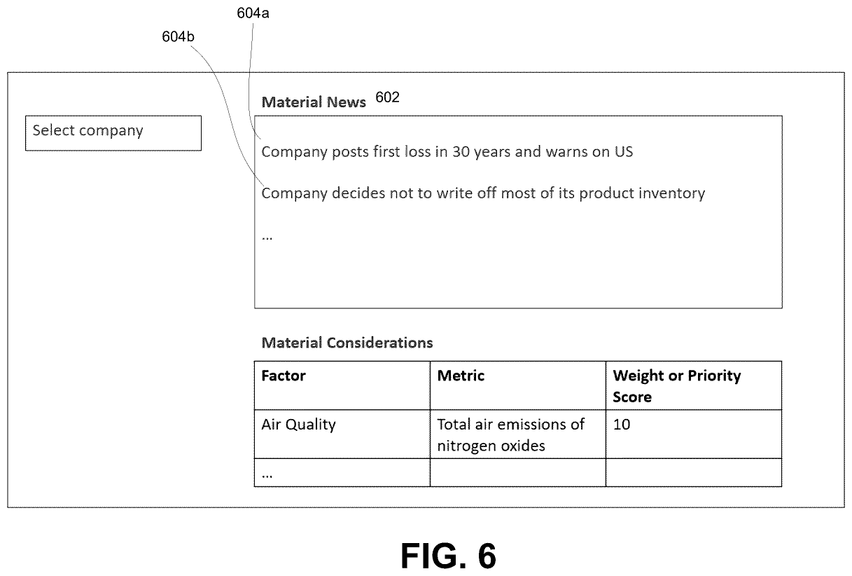

In some embodiments, identified content may be displayed in a user interface for consideration by users (e.g. the simplified dashboard interface depicted in FIG. 6, which includes headlines 602 and articles 604a, 604b). In some embodiments, selecting article 604a may result in accessing a link and displaying the full underlying article for review. For example, a dashboard user interface may be displayed to users (e.g. investment advisors), which may aid users in both assessing and communicating a company's performance relative to factors. Such a dashboard may contain model scores, financial information about a company, and a section with headlines relevant to factors and metrics which are the most material (i.e. weighted the most heavily) for that company.

In some embodiments, systems and methods described herein may facilitate the retrieval and display of news content within a dashboard interface that includes a section which displays news content (e.g., recent news headlines and/or articles) which is relevant to factors 502 and metrics 504 which are material and/or highly weighted 506 for a company according to quantitative models.

Currently, the task of identifying relevant content (e.g., news articles) is performed manually, and requires intensive analysis by subject matter experts (SMEs). For example, the task of evaluating hundreds of thousands of articles for thousands of companies on a daily basis would far exceed the capacity of human operators. Some embodiments may enable the automation of the retrieval, analysis and display of news articles, thereby facilitating access to current and relevant information for the end user, which may guide decision-making and communications.

Various embodiments disclosed herein use large language models (LLMs), such as, for example, OpenAI's GPT-4. Many LLMs are trained using large amounts of public data, which results in sophisticated language processing capabilities. However, while LLMs have knowledge of past events that were included in training data, LLMs do not have any knowledge or awareness of data which is external to the training data set. For example, external data may include new data which was not included in the original static training data set (e.g., news which happened recently or today, or private proprietary data which is internal to an institution and is not available to the public). Thus, LLMs such as GPT-4 may suffer from substandard performance when analyzing data which is recent or otherwise relates to topics not included in the training data used to train the LLM.

Some embodiments may overcome this shortcoming of LLMs by using an enhanced version of a generative artificial intelligence (GenAI) technique referred to as retrieval-augmented generation (RAG). RAG may allow LLMs to gain knowledge of external data without having to re-train the LLM.

Some embodiments first collect external data (such as news articles, and proprietary internal data). Next, the external data may be stored in a database. In some embodiments, the database is a vector database. Next, a query can be created, and the most similar subsets of external data to the query may be retrieved from the vector database. Finally, a prompt can be augmented with the retrieved information and then passed to the LLM to generate language.

Some embodiments described herein may significantly reduce the amount of time spent on manual processes. Moreover, some embodiments described herein may automate the process of retrieving relevant news articles with an emphasis on factors and metrics which are weighted the most heavily in a quantitative model. Thus, some embodiments may enhance a user's ability to assess information and make decisions using better quality information based on up-to-date and relevant information.

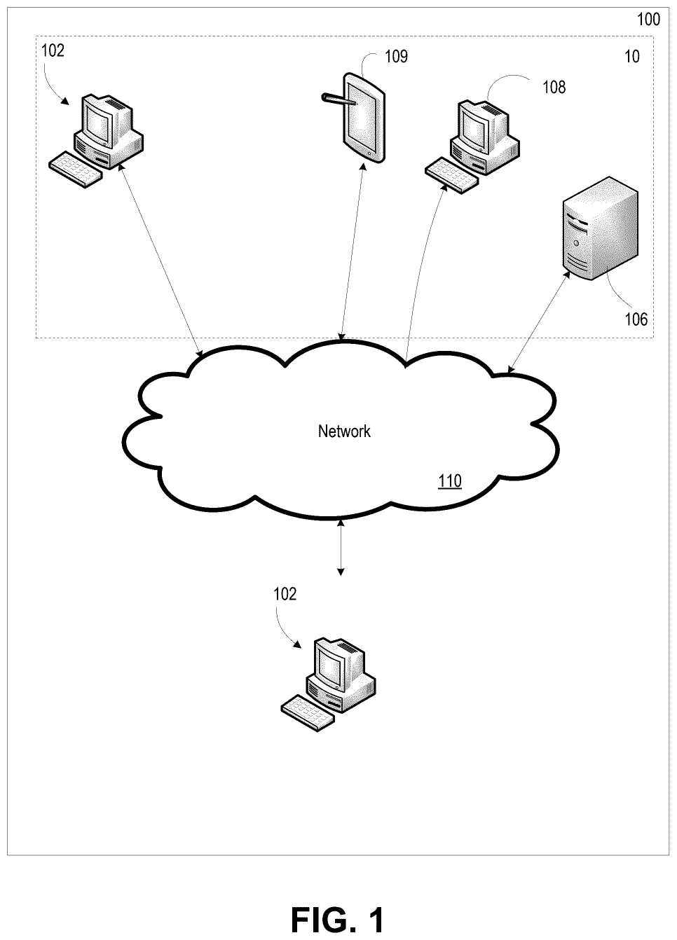

Various embodiments of the present invention may make use of interconnected computer networks and components. FIG. 1 is a block diagram depicting components of an example computing system 100. Components of the computing system are interconnected to define a content retrieval and analysis system. As used herein, the term “content retrieval and analysis system” refers to a combination of hardware devices configured under control of software and interconnections between such devices and software.

As depicted, the operating environment may include a variety of clients incorporating and/or incorporated into a variety of computing devices which may communicate with other computing devices 102 via one or more networks 110. For example, a client 102 may incorporate and/or be incorporated into client application implemented at least in part by one or more computing devices. Example computing devices may include, for example, at least one server 102 with a data storage 118 such as a hard drive, array of hard drives, network-accessible storage, or the like; at least one web server 106, and a plurality of client computing devices 108. Server 102, web server 106, and client computing devices 108 may be in communication by way of a network 110. More or fewer of each device are possible relative to the example configuration depicted in FIG. 1. In some embodiments, one or more computing devices may be logically internal to an organization 10 (depicted in FIG. 1 as devices 102, 109, 108 and 106 being internal to organization 10).

Network 110 may include one or more local-area networks or wide-area networks, such as IPv4, IPv6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE/5G networks.

In some embodiments, the computing system 100 may provide access to one or more software applications. In some embodiments, components of systems such as content retrieval and analysis system 126 may be executed locally within organization 10, without requiring the extensive computing resources of external computing platforms (such as cloud services platforms). In still other embodiments, system 126 may be executed within an organization while sending and receiving information, requests and responses to third party services external to the organization 10.

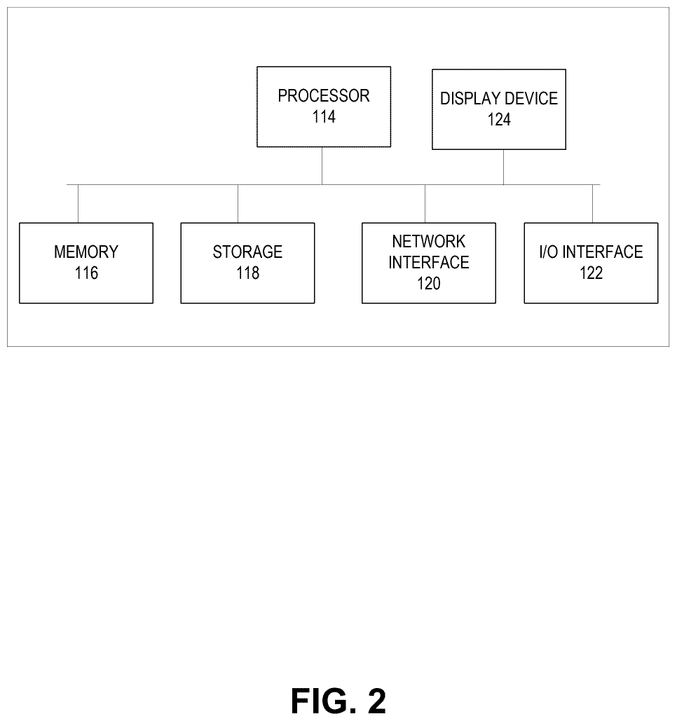

FIG. 2 is a block diagram depicting components of an example computing device, such as a desktop computing device 102, client computing device 108, tablet 109, mobile computing device, and the like. As depicted, an example computing device may include a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects the computing device to network 110. Network interface 120 may support domain-specific networking protocols for certain peripherals or hardware elements. I/O interface 122 connects the computing device to one or more storage devices and peripherals such as keyboards, mice, pointing devices, USB devices, disc drives, display devices 124, and the like.

In some embodiments, I/O interface 122 may connect various hardware and software devices used in connection with the systems and methods described herein to processor 114 and/or to other computing devices. In some embodiments, I/O interface 122 may be compatible with protocols such as WiFi, Bluetooth, and other communication protocols.

Software may be loaded onto one or more computing devices. Such software may be executed using processor 114.

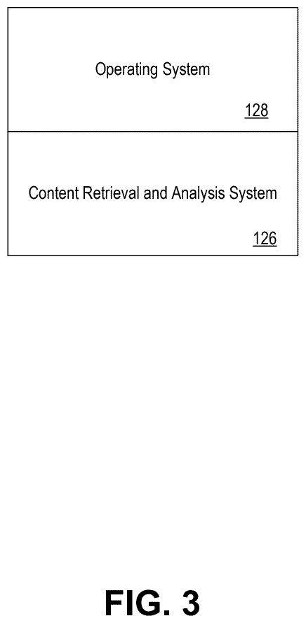

FIG. 3 depicts a simplified arrangement of software at an example computing device. The software may include an operating system 128 and application software, such as content retrieval and analysis system 126. It will be appreciated that in some computing environments, such as distributed computing environments, implementation, and administration of a service such as system 126 may be distributed amongst a plurality of separate computing devices within organization 10, and FIG. 3 is intended to depict a simplified logical separation between an operating system 128 and an application executing on one or more computing devices.

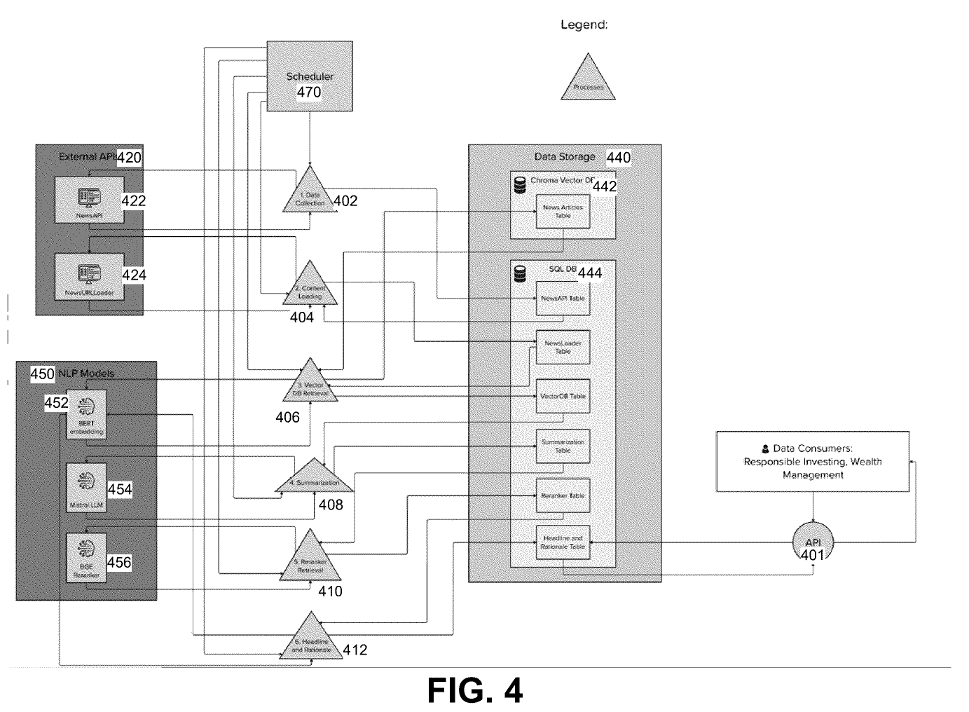

FIG. 4 depicts a logical system architecture diagram for an example embodiment of a content retrieval and analysis system 126, in accordance with some embodiments. As depicted, elements depicted using a triangle shape (e.g. 402, 404, 406, 408, 410, 412) depict processes performed by various hardware and/or software elements. In some embodiments, content retrieval and analysis system 126 may include a scheduler 470. In some embodiments, schedule 470 is configured to coordinate and execute data collection block 402, content loading block 404, vector database retrieval block 406, summarization block 408, reranker retrieval block 410, and headline and rationale generation block 412. Each of the aforementioned processes may interact with or otherwise make use of one or more of external APIs 420, NLP models 450, and data storage 440.

In some embodiments, external APIs 420 may include one or more of a news retrieval API (e.g. NewsAPI 422) and a news URL loading API (e.g. NewsURLLoader 424).

In some embodiments, natural language processing (NLP) models 450 may include one or more of a Bidirectional Encoder Representations from Transformers (BERT) embedding model 452, a large language model (e.g. Mistral LLM 454), and an embedding model (e.g. Beijing General Embedding (BGE) reranker 456. It will be appreciated that numerous other types of NLP models may be suitable for various embodiments, depending on the requirements of the particular system and the types of data being analyzed.

In some embodiments, data storage 440 may include a vector database 442 (e.g., chroma vector database). In some embodiments, vector database 442 may be configured to store a table of news articles.

In some embodiments, data storage 440 may include a database 444 (e.g., SQL database 444). As depicted, SQL database 444 may include one or more of a newsAPI table, a NewsLoader table, a VectorDB table, a summarization table, a reranker table, and a headline and rational table. In some embodiments, the headline and rationale table may be accessible by users (e.g. financial advisors, wealth advisors, and the like) via API 401.

As depicted, in some embodiments, data collection block 402 comprises collecting news article data. For example, an organization may internally maintain a private set of data. In some embodiments, such data may include a list of companies, and the material factors and metrics associated with each respective company. In some embodiments, the private data may be maintained and/or provided in a spreadsheet format (e.g., Microsoft Excel format, although it will be appreciated that any suitable data format may be used).

In some embodiments, for the initial data collection at block 402, a news retrieval API 422 (e.g. NewsAPI, available at https://newsapi.org) may be used. The news retrieval API 422 may be configured to, for example, retrieve news articles based on, for example, any of keyword searches, news sources, and date ranges. It will be appreciated that in some embodiments, news retrieval APIs other than NewsAPI may be used, and that the embodiment described herein is merely an example embodiment. In some embodiments, for each retrieved news article, one or more of its title, description, partial content, URL link, news source, and/or publication data may be stored. In some embodiments, such data may be stored in the NewsAPI table in SQL database 444.

In some embodiments, a keyword search may be performed for a company name. In some embodiments, the company name may be input to an “article title” field. In some embodiments, company suffixes such as “Inc.” or “Corp.” may be omitted from a keyword search (as such words are frequently omitted from article headlines). In some embodiments, the news retrieval API 422 may be further configured to search from a subset of news sources. For example, some news sources may be viewed as less reliable than other news sources, and searches can be limited to sources which any of preferred by the user, and/or perceived as meeting a threshold level of reliability and/or trustworthiness.

In some embodiments, news retrieval API 422 might return partial contents of news articles. As such, in some embodiments, news URL loader 424 may be used to access the full content of the retrieved articles. For example, an example news URL loader may be the “News URL” service (available at https://python.langchain.com/docs/integrations/document_loaders/news/). In some embodiments, the News URL service is configured to accept the URL link of a news article as an input, and return the full content of the article (provided the content of the URL can be web scraped). It will be appreciated that other news retrieval APIs may be used (e.g., the BeautifulSoup API). In some embodiments, the news retrieval API may be configured to strip advertising, headlines of other articles (e.g. headlines for other articles which may appear in the side margins of a web page), and/or blank spaces from retrieved news articles. An API such as News URL may be configurable to perform the aforementioned stripping. This may result in more efficient usage of storage, as well as more accurate end results (as less extraneous text and content will be considered in subsequent processes described herein).

In some embodiments, scheduler 470 may be configured to execute a loop which may be used to call the news URL loader 424 for each article URL more than once (e.g., in case of data connection instability and/or connections timing out).

In some embodiments, block 406 may include storing information in vector database 442. In some embodiments, the title and description of each news article stored in SQL database 444 may be retrieved and transformed to a vector. For example, the title and description of a news article may be stored in a vector database 442 as a collection of words. It will be appreciated that transforming the full text content of an article as a vector might not be desirable, as it would be unlikely for one single vector to represent the entire text content of an article accurately.

In some embodiments, an NLP model 450 such as a BERT embedding model 452 may be used to transform the title and description of a news article to a vector. This vector may then be stored in vector database 442. In some embodiments, metadata may be added to a vector in the vector database 442. For example, the name of the company associated with vector may be stored as metadata. Storing the company name associated with a vector may be useful in that subsequent steps of the process may be filtered by company name, thereby avoiding the unnecessary processing of vector database entries 442 which are unrelated to the particular company which is the subject of a query.

In some embodiments, once vector database 442 contains vector database entries, relevant vectors may be retrieved from vector database 442 by providing a query to vector database 442. For example, a query may include, for a particular company, a factor and/or metric for that particular company. Thus, some embodiments may allow for queries to focus in on particular factors and/or metrics for a company, rather than a more broad query for all factors. For example, in some embodiments, the factors and/or metrics which have been assigned the highest weight/priority for a particular company may be included in the query.

In some embodiments, the query may be converted to a vector by embedding model 452. The vector database may then compare the vector-transformed query to the stored vectors in vector database 442, and may return the collections of words whose vectors are the most similar to the vector representation of the query. In some embodiments, similarity may be determined using, for example, a formula based on Euclidian distance, where the shortest “distance” between the query and vectors stored in database 442 are the most similar. In some embodiments, the articles having the highest similarity may be stored in a vectorDB table within SQL database 444.

In some embodiments, filtering queries using metadata associated with vectors in vector database 442 may facilitate limiting the results of queries to articles which relate to a target company. Further, by including a factor and/or metric in the query, this may allow queries to vector database 442 to be focused on a particular factor and/or metric for a particular company, which may enhance the accuracy of query results. Moreover, the retrieved articles for each query may become matched with the factor and/or metric included in the query.

In some embodiments, vector database 442 may be a Chroma vector database (such as that which is available at https://python.langchain.com/docs/integrations/vectorstores/chroma/). In some embodiments, the embedding model may be, for example, the sentence-transformers/all-mpnet-base-v2 embedding model (available online at https://api.python.langchain.com/en/latest/embeddings/langchain_community.embeddin gs huggingface.HuggingFaceEmbeddings.html). However, it will be appreciated that these are merely examples of types of vector databases and embedding models, and that other vector database configurations and embedding models may be suitable depending on the particular application and parameters.

In some embodiments, at block 408, one or more articles returned as a result of the query may be retrieved and summarized using an LLM 454. In some embodiments, summarization of an article may include specifying how an article mentions the factor and/or metric with which the article was matched.

It will be appreciated that numerous different large language models are contemplated and may be used to generate summarizations, including but not limited to GPT-4 by OpenAI, the Mistral 7B open-source LLM (available online at: https://mistral.ai/news/announcing-mistral-7b/), as well as many other open-source and/or proprietary LLMs.

To summarize a news article, a prompt may be sent to the LLM which specifies that a targeted summary with respect to the factor and/or metric is desired, and the LLM will generate and output a targeted summary in response.

In some embodiments, prior to generating a summarization of an article, the LLM 454 may be used to determine whether the article is relevant (or not) to the matched factor and/or metric. For example, it is possible that the query to the vector database 442 may return “false positive” results, which might not actually be relevant to the matched factor and/or metric. For example, an article might have a title which includes the wording of a factor and metric, in the context of explicitly stating that the article is not related to that factor and metric.

In some embodiments, the LLM may be provided with a prompt which specifies that the output response must be Boolean (i.e. a response of “true” or “false”). In this manner, the LLM may be used as a classifier. Thus, the LLM 454 may be prompted to determine whether a given article is relevant to a factor and/or metric. In some embodiments, processing resources, time, and/or energy may be saved by selecting only the articles that are classified as “true” for relevance by the LLM for summarization. In some embodiments, the generated summary of a news article may be stored in a summarization table of SQL database 444.

In some situations, the transformation of documents into vectors may cause information loss (as vectors are compressions of the meaning behind the text into dimensional vectors, e.g. 768-dimensional vectors). As such, it is possible that the vectors having the highest similarity score relative to a query might not always contain the most relevant information, whereas it is also possible documents having lower similarity scores might include pertinent information which might improve the overall output from an LLM. Thus, including additional documents having lower relevance scores might improve the accuracy of the overall output from the LLM. However, increasing the number of documents may negatively impact the performance of an LLM and require additional computing resources, which is undesirable in environments with finite resources. In some embodiments, system 126 uses a reranking process to re-order the retrieved documents to increase the likelihood that the most relevant documents are used by the LLM. In some embodiments, reranking may provide additional performance gains without requiring the processing of additional documents (or as many documents) by the LLM.

In some embodiments, a reranker (such as BGE reranker 456 depicted in FIG. 4) may be a transformer-based model which can receive 2 inputs (e.g. 2 text sentences) and output a similarity score that represents the similarity between the 2 inputs. Rerankers tend to be more accurate/precise than a vector database, but also more time-intensive and compute-intensive. In some embodiments, at block 410, reranker 456 may be provided with two inputs (e.g., the summarization of a news article, and the material factor and metric that were matched to the article by the vector database query). In so doing, reranking block 410 may output an indication of the similarity of the news article to the factor and/or metric to which the news article was matched.

Thus, articles which had relatively high similarity scores via the comparison between the vector query to the vector database 442, might be re-ordered by reranker 456 to an order which is different from the similarity scores (which were obtained based on the distance between query and vector from the vector database 442). In some embodiments, the reranked articles may be stored in reranker table of SQL database 444. This may improve the accuracy and performance of system 126.

In some embodiments, determining the articles with the highest similarity scores may be performed using a heap data structure. A heap data structure may be particularly advantageous in the case of the Python language, which is particularly computationally efficient at returning the smallest number (using a so-called “min-heap” approach). In some embodiments, in order to leverage the superior performance of the min-heap functionality in Python, similarity scores may be converted to negative numbers (e.g., multiplied by −1) and stored in a min-heap. In some embodiments, similarity scores may be modified based on the priority weight or score for the particular factor and/or metric in question for the particular company. From the heap, the articles with the best scores may be retrieved efficiently, and may represent those articles which are the most similar with their matched factor and/or metric.

At block 412, news articles having the highest ranking in reranker table of SQL database 444 are retrieved. In some embodiments, a large language model 454 may be provided with a prompt to generate a new headline for the news articles which better represents how the material factor and/or metric are discussed in each respective news article. In some embodiments, the LLM 454 may be prompted to generate a rationale explaining why a particular article was selected and/or ranked the way it was. In some embodiments, the prompt may include an instruction to restrict the headline and rationale to numbers and other factual statements that are explicitly stated in the article. Limiting the headline and rationale to explicit numbers and factual statements may reduce and/or prevent hallucinations from being included in the generated headline and rationale.

In some embodiments, a user may send an instruction to an application programming interface (API) 401 to retrieve news headlines for a company. In some embodiments, the API may be configured to access SQL database 444, and return a list of the highest-ranked articles from the headline and rationale table. In some embodiments, the API may return the articles having the 3 highest scores. In other embodiments, the API may return the articles having the 5 highest scores. In some embodiments, the user may specify the number of articles to be returned. It will be appreciated that the number of articles returned may vary depending on the scenario, and any suitable number may be returned.

In some embodiments, the user may instruct scheduler 470 to initiate one or more of blocks 402, 404, 406, 408, 410 and 412. In still other embodiments, schedule 470 may operate autonomously or automatically, and update the contents of vector database 442 and SQL database 444 continuously. In some embodiments, such updates may occur on periodic basis. In other embodiments, such updates may be performed in accordance with a schedule. Some examples of a schedule may be hourly, daily, monthly, or any other suitable time period depending on the needs of the user.

In some embodiments, system 126 may perform blocks 406, 408, 410 and 412 for individual factors 502 and metrics 504 at a time. For example, rather than creating a query for vector database 442 which includes all or a plurality of factors and/or metrics, the system 126 may provide substantially superior results in terms of accuracy and/or relevance when queries and subsequent matching and summarizing are focused on a specific factor and metric at a time. Thus, in some embodiments, scheduler 470 may execute a loop which cycles through each factor and/or metric for a company separately. In some embodiments, such a loop may begin with factors and metrics which have the highest priority weighting 506, with subsequent iterations performed for factors and metrics which have progressively lower priority weightings 506.

Some embodiments described herein may provide significant improvements in efficiency in terms of the number of processing cycles and computing resources required by an organization to implement system 126. For example, processes 402, 404, 406, 408, 410, 412 may provide a conceptual ‘funnel’ which successively reduces the amount of articles which will ultimately be reviewed by human operators. For example, in a 5 year time window, a search for news articles in which a company name appears in the title might be greater than 100,000 articles. By converting the headline and metrics into a vector database and querying the vector database, the amount of articles might be greatly reduced but still greater than 1,000 articles. By using an LLM as a classifier for relevance to a factor or metric and summarizing articles, the amount of articles might be reduced ten-fold. Finally, by using a re-ranker on the remaining articles, the number of relevant articles may be reduced further still, to a manageable amount. By selecting the articles with the highest scores from the re-ranker (e.g. the top 3 articles), the system can effectively reduce the workload for a human operator to the review of a few articles which will be highly relevant to the company and most material factors and metrics.

Moreover, systems and methods described herein may offer significant improvements over other strategies for identifying news articles relevant to factors and metrics. For example, a system which converts articles to a vector database and uses a re-ranker might provide acceptable relevance for factors, but may be unreliable in providing relevance for metrics. The use of LLMs may enable better representation of news articles for the vector database and re-ranker blocks, which improves the sophistication of the output and may in fact produce new outputs, which result in significantly higher rates of articles which match factors and metrics.

Of course, the above-described embodiments are intended to be illustrative only and in no way limiting. The described embodiments are susceptible to many modifications of form, arrangement of parts, details, and order of operation. The invention is intended to encompass all such modifications within its scope, as defined by the claims.

What is claimed is:

1. A method of retrieving content for a company having a company name, the method comprising:
receiving a quantitative model for said company, the quantitative model including a plurality of factors, each of said factors having one or more metrics associated therewith, and each of said one or more metrics having a priority weighting indicative of the materiality of the metric;
retrieving, by a news retrieval service, a plurality of news articles for said company, said news articles including at least a title and description;
converting, by a natural language processing (NLP) embedding model, for each said news articles, said title and said description to a vector comprising a plurality of words;
storing each of said vectors in a vector database;
generating a query including one of said factors and one of said metrics;
converting said generated query to a query vector;
determining, based on said vector query, a similarity score for each of said vectors based on said query vector;
returning a set of query results, said query results comprising the vectors having the highest similarity scores for said query vector;
for each of said set of query results, classifying the vector as one of relevant or not relevant to said one of said factors and said one of said metrics;
generating, using said large language model (LLM), a set of summarizations, said set of summarizations including a summarization of each of said set of query results classified as relevant to said one of said factors and said one of said metrics, wherein each of said summarizations is based on a full text content of said corresponding article for said vector determined to be relevant;
determining, using a reranker, a similarity score for each of said summarizations in said set of summarizations with said one of said factors and said one of said metrics;
selecting a plurality of said summarizations from said set of summarizations, said selected summarizations having the highest similarity scores from said set of summarizations;
generating, by an LLM, a headline for each of said articles corresponding to said selected summarizations, and generating a rationale for each of said articles corresponding to said selected summarizations articulating why said article was selected; and
displaying, in a user interface, each of said generated headlines and rationales for said articles corresponding to said selected summarizations.

2. The method of claim 1, wherein said one of said metrics has the highest priority weighting for said company.

3. The method of claim 1, wherein said generating a query comprises generating separate queries for each of said factors and metrics for said company.

4. The method of claim 3, wherein each of said separate queries comprises a single factor and a single metric.

5. The method of claim 1, wherein each of said retrieved news articles further comprises at least one of partial content, a URL link, a news source, and/or a publication date.

6. The method of claim 1, wherein said classifying said vector as relevant or not relevant comprises sending a prompt to said LLM instructing said LLM to provide a true or false output for said relevance of said vector.

7. The method of claim 1, wherein said vector comprises metadata including said company name.

8. The method of claim 7, wherein said determining said similarity score for each of said vectors based on said query vector comprises determining said similarity score for vectors having said metadata corresponding to said company name.

9. The method of claim 1, wherein selecting one of said generated headlines and/or rationales in said user interface activates a link to a corresponding article.

10. The method of claim 1, wherein said similarity scores are converted to negative numbers prior to said selecting.

11. The method of claim 1, wherein said selecting said summarizations having said highest similarity scores comprises storing said similarity scores in a heap data structure.

12. The method of claim 1, wherein generating said headline and said rationale comprises sending prompts to said LLM restricting content of said headline and said rationale to numbers and factual statements explicitly stated in said article.

13. The method of claim 1, wherein said vectors are 768-dimensional vectors.

14. A system comprising:
a processor; and
a computer-readable storage medium having stored thereon computer-executable instructions that, when executed by said processor, cause the processor to perform a method comprising:
receiving a quantitative model for said company, the quantitative model including a plurality of factors, each of said factors having one or more metrics associated therewith, and each of said one or more metrics having a priority weighting indicative of the materiality of the metric;
retrieving, by a news retrieval service, a plurality of news articles for said company, said news articles including at least a title and description;
converting, by a natural language processing (NLP) embedding model, for each said news articles, said title and said description to a vector comprising a plurality of words;
storing each of said vectors in a vector database;
generating a query including one of said factors and one of said metrics;
converting said generated query to a query vector;
determining, based on said vector query, a similarity score for each of said vectors based on said query vector;
returning a set of query results, said query results comprising the vectors having the highest similarity scores for said query vector;
for each of said set of query results, classifying the vector as one of relevant or not relevant to said one of said factors and said one of said metrics;
generating, using said large language model (LLM), a set of summarizations, said set of summarizations including a summarization of each of said set of query results classified as relevant to said one of said factors and said one of said metrics, wherein each of said summarizations is based on a full text content of said corresponding article for said vector determined to be relevant;
determining, using a reranker, a similarity score for each of said summarizations in said set of summarizations with said one of said factors and said one of said metrics;
selecting a plurality of said summarizations from said set of summarizations, said selected summarizations having the highest similarity scores from said set of summarizations;
generating, by an LLM, a headline for each of said articles corresponding to said selected summarizations, and generating a rationale for each of said articles corresponding to said selected summarizations articulating why said article was selected; and
displaying, in a user interface, each of said generated headlines and rationales for said articles corresponding to said selected summarizations.

15. A computer-readable storage medium having stored thereon computer-executable instructions that, when executed by said processor, cause the processor to perform a method comprising:
receiving a quantitative model for said company, the quantitative model including a plurality of factors, each of said factors having one or more metrics associated therewith, and each of said one or more metrics having a priority weighting indicative of the materiality of the metric;
retrieving, by a news retrieval service, a plurality of news articles for said company, said news articles including at least a title and description;
converting, by a natural language processing (NLP) embedding model, for each said news articles, said title and said description to a vector comprising a plurality of words;
storing each of said vectors in a vector database;
generating a query including one of said factors and one of said metrics;
converting said generated query to a query vector;
determining, based on said vector query, a similarity score for each of said vectors based on said query vector;
returning a set of query results, said query results comprising the vectors having the highest similarity scores for said query vector;
for each of said set of query results, classifying the vector as one of relevant or not relevant to said one of said factors and said one of said metrics;
generating, using said large language model (LLM), a set of summarizations, said set of summarizations including a summarization of each of said set of query results classified as relevant to said one of said factors and said one of said metrics, wherein each of said summarizations is based on a full text content of said corresponding article for said vector determined to be relevant;
determining, using a reranker, a similarity score for each of said summarizations in said set of summarizations with said one of said factors and said one of said metrics;
selecting a plurality of said summarizations from said set of summarizations, said selected summarizations having the highest similarity scores from said set of summarizations;
generating, by an LLM, a headline for each of said articles corresponding to said selected summarizations, and generating a rationale for each of said articles corresponding to said selected summarizations articulating why said article was selected; and
displaying, in a user interface, each of said generated headlines and rationales for said articles corresponding to said selected summarizations.
